(19) United States
(12) Patent Application Publication
(10) Pub. No.: US 2008/0192903 A1
(43) Pub. Date: Aug. 14, 2008

(54) SYSTEM AND METHOD FOR FACILITATING VOICE COMMUNICATION USING PRESENCE SERVICES

(76) Inventor: Trung (Tim) Trinh, Nepean (CA)

Correspondence Address: INTER-TEL (DELAWARE), INC.;A MITEL COMPANY, 7300 WEST BOSTON STREET, CHANDLER, AZ, 85226, US

(21) Appl. No.: 11/674,793

(22) Filed: Feb. 14, 2007

(51) Int. Cl. H04M 11/00; H04M 1/64; H04M 3/42

(52) U.S. Cl. 379/88.16; 379/201.1; 379/88.19

(57) ABSTRACT

A system and method for facilitating communication between a first user and a second user in which contact information is received for said second user at a presence query task, via an adjunct application server. The presence status of the second user is checked and sent to the adjunct application server. The presence status is then provided from the adjunct application server, through a telephony switch to the first user. The presence status is provided to the first user in the form of an audible indication.

### FIELD OF THE INVENTION

The present invention relates to facilitation of effective communications using presence information in voice communication applications.

### BACKGROUND OF THE INVENTION

Presence services are an emerging technology that provide information of user's availability and capabilities. Such presence services are primarily used for providing availability information of one or more users to another user of a system. This availability information includes an indication of availability or willingness of the user to engage in immediate communication. For example, through visual monitoring of desktop computer applications or smart telephony device applications, a user is provided with availability information of another user, prior to making a telephone call.

Existing presence services rely on desktop presence-enabled applications or smart telephony device presence-enabled applications for the provision of availability information of a user. In the absence of such desktop presence-enabled applications or smart telephony device presence-enabled applications, presence services are not possible. Non-knowledge workers or workers that do not have any presence enabler application for determining presence are not provided with any presence information.

Such presence services suffer further inherent disadvantages in that presence information is not provided at a convenient time and in a convenient manner when a user is engaged in communication-related activities. For example, a call-back option is commonly provided when a user is engaged in a voice mail session, allowing the user to conveniently place a call to a voice mail sender. Alternatively, a user that exits a voice mail session, may wish to make a phone call immediately upon completion of the voice mail session. In such instances, current presence information is not available to the user. Thus, such telephone calls are made without knowledge of availability of the voice mail sender, commonly resulting in the caller being connected to a voice mail system.

Improvements in presence services for providing presence-related information in the absence of desktop presence-enabled applications or smart telephony device presence-enabled applications are therefore desirable.

### SUMMARY OF THE INVENTION

According to one aspect, there is provided a method for facilitating communication between a first user and a second user. The method includes receiving contact information for the second user at a presence query task, via an adjunct application server, checking to determine presence status of the second user, providing the presence status from the adjunct application server, and providing the presence status from the adjunct application server through a telephony switch to the first user, the presence status provided to the first user in the form of an audible indication.

According to another aspect, there is provided a system for facilitating communication between a first user and a second user. The system includes a telephone switch for connecting a first user telephony device with a second user telephony device, an adjunct application server connected to the telephone switch, and a presence query task operating with the adjunct application server by connection to or as part of the adjunct application service for checking to determine presence status of the second user and sending the presence status to the adjunct application server in response to a query received from the adjunct application server. The adjunct application server receives the presence status from the presence query task and provides the presence status to the telephony switch in the form of an audible indication,

External presence information such as availability status, for example, online, offline, busy, or on-the-phone, is conveniently announced to a party who is trying to place a call or who is accessing voice mail messages. Thus, a visual indication of availability is not necessary.

Advantageously, the calling party receives presence information for the called party in real time while the call is being made, without the need for a visual device or application for the calling party to view. Instead, the presence information is provided audibly by, for example, an announcement or a tone, using existing telephony devices. Further, the presence information of a voice mail sender can be provided while a user is accessing voice mail messages, thereby providing information for the user to determine a desired action to take in response to receipt of the voice mail message(s). The invention leverages external presence information such as status including, for example, online, offline, busy or on-the-phone status and provides an audible indication of such to a user who is placing a call or accessing voice mail.

### BRIEF DESCRIPTION OF THE DRAWINGS

Embodiments of the present invention will now be described, by way of example only, with reference to the attached Figures, wherein:

FIG. 1 is a simplified representation of a communication system for implementing a method for facilitating communication using presence services, according to one embodiment of the present invention;

FIG. 2 is a flowchart of a method for facilitating communication using presence services according to an embodiment; and

FIG. 3 is a simplified representation of a communication system for implementing a method for facilitating communication using presence services according to another embodiment of the present invention.

### DETAILED DESCRIPTION OF THE INVENTION

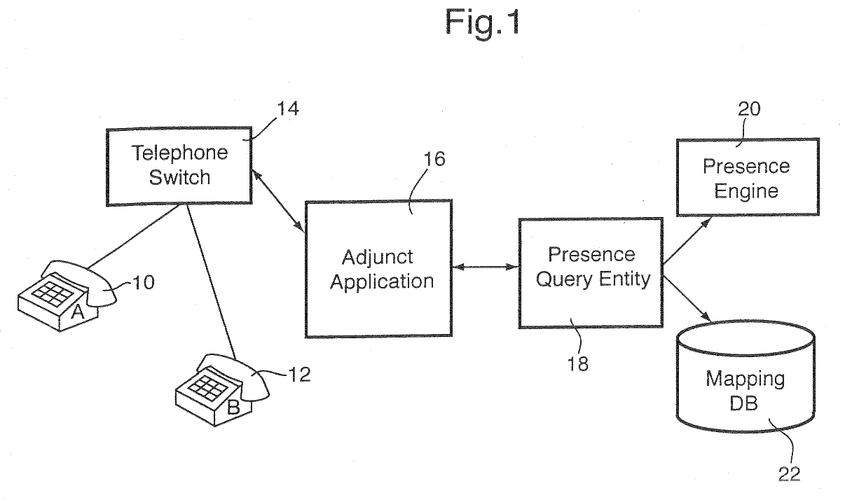

Reference is first made to FIG. 1 to describe a communication system for implementing a method for facilitating communication using presence services, according to an embodiment. As shown, a first telephone device 10 of a first user and a second telephone device 12 of a second user are both connected to a telephony switch 14 that is responsible for telephony connections between the first telephone device 10 and the second telephone device 12. The telephone switch 14 is connected to an adjunct application server 16 such as an auto-attendant server, a voice mail server or an interactive voice response (IVR) server. In turn, the adjunct application server 16 is connected to a presence query task 18 that receives presence queries from the adjunct application server 16 and provides responses in the form of audible presence status information to the adjunct application server 16. The presence query status task 18 is connected to a presence engine 20 that provides presence status information to the presence query task 18, for users, including presence status information for the first user and for the second user. It will be appreciated by those skilled in the art that the presence engine 20 provides presence information by monitoring devices and applications to determine a user's presence. A mapping database 22 is also connected to the presence query task 18 for mapping the presence status information provided by the presence engine 20, to audible presence status information in the form of an audible indication or announcement. It will be appreciated that the functions provided by the adjunct application server 16, the presence query task 18, and the mapping database 22 can be embodied in the same device.

For the purpose of simplicity, only two telephone devices, the first telephone device 10 and the second telephone device 12, are shown. It will be appreciated that many other telephone devices can be connected to the telephony switch 14. It will also be appreciated that the telephony switch 14 can be any switch that handles connections between telephone devices and that the telephony switch 14 and the adjunct application server 16 can be embodied in a single unit such as, for example a PBX. As indicated above, FIG. 1 is a functional representation and it will be appreciated that the presence query task 18 and the mapping database 22 can be embodied in the same device.

For the purpose of the present example, the first telephone device 10 is a desk telephone connected to the telephony switch 14. Similarly, the second telephone device 12 is a desk telephone connected to the telephony switch 14

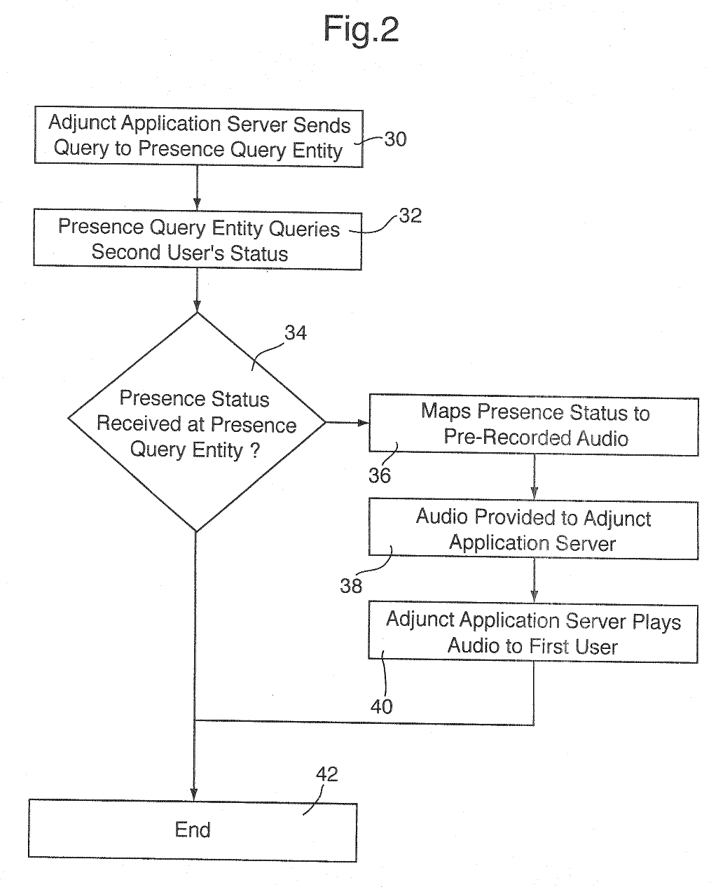

Referring now to FIG. 2, there is shown a flow chart of a method for facilitating communication using presence services according to an embodiment. The first user employs the use of the adjunct application server 16 during telephony operations. At step 30, the adjunct application server 16 sends a query to the presence query task 18. The query includes an identifier such as a telephone number of a uniform resource identifier (URI) of the second telephone device 12 of the second user. At step 32, the presence query task 18 uses the identifier of the second telephone device 12 to query the second user's presence status from the presence engine 20. As indicated above, the presence engine 20 provides presence information by monitoring devices and applications to determine a user's presence.

If a presence status is received at the presence query task 18 from the presence engine 20, then the presence query task 18 searches the mapping database 22 to map the presence status received at step 34 to an appropriate audible presence status notification such as a tone, tone pattern or a pre-recorded audible announcement at step 36. The audible presence status notification is then forwarded to the adjunct application server 16 at step 38 and is played by the adjunct application server 16 to the first telephone device 10 at step 40. In addition to pre-recorded audio announcements based on system-defined presence states such as on-line, off-line, etc., custom presence status indications can be defined and set by individual users. A text-to-speech prompt is dynamically generated according to the text defined by the user. The presence service ends at step 42. As shown in FIG. 2, if there is no presence status available for the second user or the method times out while waiting for the presence status and therefore no presence status is received at step 34, the presence service ends at step 42.

To assist in the explanation of the method for facilitating communication using presence services, the method is now described by way of example with reference to the foregoing discussion.

For the purpose of the present example, the adjunct application server 16 is an auto-attendant application. According to the present example, the first user wishes to talk to the second user. The first user calls and is connected to the telephony switch's auto-attendant application (adjunct application server 16). The first user is then presented with an option to input a number to call another user (the second user). The first user then enters the telephone number of the second telephone device 12 to call the second user, using a keypad on the first telephone device 10 and the number entered is validated by the adjunct application server 16.

Next, the adjunct application server 16 sends a query to the presence query task 18 and, as described above, the query includes the identifier of the second telephone device 12 (step 30). As indicated above, the identifier can be a telephone number or a URI, for example. The presence query task 18 uses the identifier of the second telephone device 12 to query the second user's presence status from the presence engine 20. If a presence status is received at the presence query task 18 from the presence engine 20, then the presence query task 18 searches the mapping database 22 to map the presence status received at step 34 to an appropriate pre-recorded audible presence status announcement at step 36. The content of the pre-recorded audible presence status announcement is then forwarded to the adjunct application server 16 at step 38 and is played by the adjunct application server 16 to the first telephone device 10 at step 40. Alternatively, a pointer to the location of the content of the pre-recorded audible presence status announcement is forwarded to the adjunct application server 16 at step 38 and the adjunct application server 16 uses the pointer to locate and play the pre-recorded audible presence status announcement to the first telephone device 10 at step 40. Thus, after entering the phone number for the second telephone device 12, the pre-recorded audible presence status announcement is played to the first user to announce the presence status of the second user. For example, the announcement can indicate that the second user is offline, online, busy or on-the-phone, prior to transferring (causing the second telephone device 12 to ring). Based on the presence status of the second user, options for call handling can be provided to the first user. For example, in the event that the second user is busy, options are provided to the first user to connect to an alternate number, such as a secretary, at another telephone device (not shown in FIG. 1) or to go directly to voice mail to leave a message for the second user.

The presence service ends at step 42. As shown in FIG. 2, if there is no presence status available for the second user, the presence query task 18 receives a NIL value from the presence engine 20 or times out and therefore no presence status is received at step 34. The presence service then ends at step 42. It will be appreciated that the functions of the adjunct application server 16 do not end at step 42. Instead, only the presence query task 18 operation ends.

Another example will now be described to further assist in the explanation of the method for facilitating communication using presence services. For the purpose of the present example, the adjunct application server 16 is a voice mail application. According to the present example, the second user previously called the first user and left a message using the voice mail application. In response to a message waiting indication at the first telephone device 10, the first user connects to the voice mail application (adjunct application server 16) to listen to the voice message left by the second user. The first user is presented with an option to play the voice message left by the second user. In response to selection of the option to play the voice message, the adjunct application server 16 sends a query to the presence query task 18 and, as described above, the query includes the phone number of the second telephone device 12 (step 30). In the present example, the first user does not enter the phone number of the second telephone device 12. Instead, the phone number is retrieved from the message information.

The presence query task 18 uses the telephone number of the second telephone device 12 to query the second user's presence status from the presence engine 20. If a presence status is received at the presence query task 18 from the presence engine 20, then the presence query task 18 searches the mapping database 22 to map the presence status received at step 34 to an appropriate pre-recorded audible presence status announcement at step 36. The prerecorded audible presence status announcement is then forwarded to the adjunct application server 16 at step 38 and is played by the adjunct application server 16 to the first telephone device 10 at step 40. Thus, the pre-recorded audible presence status announcement is played to the first user to announce the presence status of the second user. For example, the announcement can indicate that the second user is online, offline, busy, on-the-phone or any other suitable announcement.

The presence service ends at step 42. As shown in FIG. 2, if there is no presence status available for the second user, the presence query task 18 receives a NIL value from the presence engine 20 and therefore no presence status is received at step 34. The presence service then ends at step 42. Again, it will be appreciated that the functions of the adjunct application server 16 do not end at step 42. Instead, only the presence query task 18 operation ends.

The first user is therefore provided with the pre-recorded announcement prior to hearing the telephone message. For example, the message can be introduced as “Message 1, from B. Taylor on January 31, status online”. The first user can then determine whether or not to call the second user back based on the presence status provided. Alternatively the first user is provided with the pre-recorded announcement after the voice message is played.

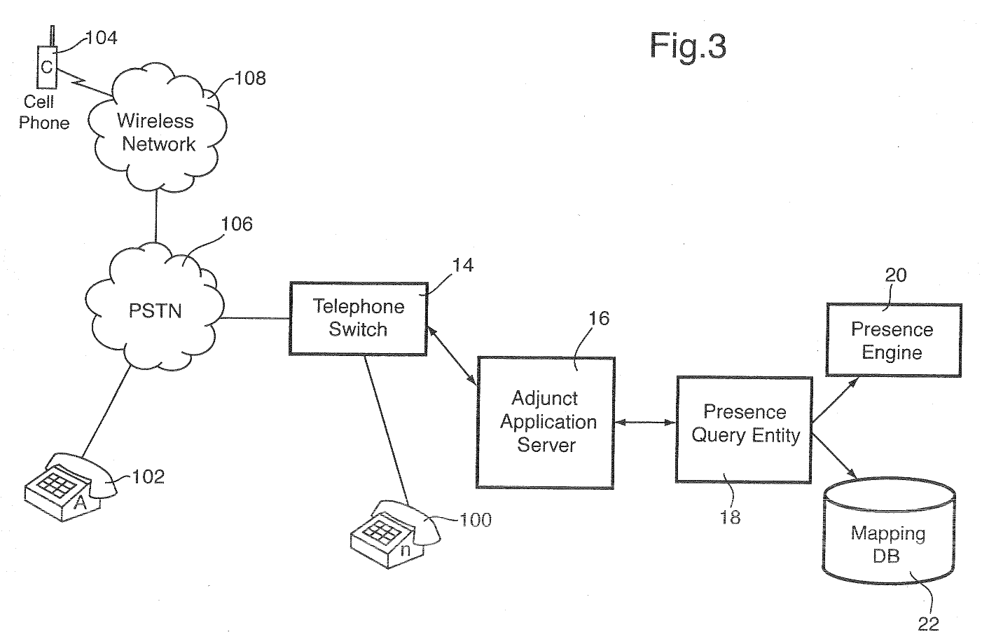

Reference is now made to FIG. 3 to describe a communication system for implementing a method for facilitating communication using presence services according to another embodiment of the present invention.

According to the present exemplary embodiment, an internal telephone device 100 of an internal user is connected to a telephony switch 14 that is responsible for telephony connections between the internal telephone device 100 and other telephony devices. The telephone switch 14 is connected to an adjunct application server 16 such as an auto-attendant server a voice mail server, or an interactive voice response (IVR) server. In turn, the adjunct application server 16 is connected to a present query task 18 that receives presence queries from the adjunct application server 16 and provides responses in the form of audible presence status information to the adjunct application server 16. The presence query task 18 is connected to a presence engine 20 that provides presence status information to the presence query task 18, for users, including presence status information for the internal telephone device user. It will be appreciated by those skilled in the art that the presence engine 20 provides presence information by monitoring the internal telephone device and applications to determine the internal user's presence. A mapping database 22 is also connected to the presence query task 18 for mapping the presence status information in the form of an audible indicating or announcement. It will be appreciated that the functions provided by the adjunct application server 16, the presence query task 18, and the mapping database 22 can be embodied in the same device.

As shown in FIG. 3, the telephone switch 14 is also connected to a public switched telephone network (PSTN) which is connected to an external telephone device 102 of an external user. The PSTN is further connected to a wireless network 108 which is connected to a cellular telephone device 104 of a cell phone user. It will be appreciated that the cellular telephone device 104 can be, for example, any device with cellular telephone functionality, including, for example, a cellular phone and a smart phone.

For the purpose of simplicity, only a single telephone device is shown connected directly to the telephone switch 14. Similarly only a single telephone device is shown connected to the PSTN 106 and a single telephone device is shown connected to the wireless network. It will be appreciated, however, that many other telephone devices can be connected to the PSTN and many other telephone devise can be connected to the wireless network. It will also be appreciated that the telephony switch 14 can be any switch that handles connections between telephone devices and that the telephony switch 14 and the adjunct application server 16 can be embodied in a single unit such as, for example, a PBX. As in the first-described embodiment, FIG. 3 is a functional representation and it will be appreciated that the presence query task 18, and the mapping database 22 can be embodied in the same device and can be part of a PBX, for example.

Referring again to FIG. 2, the external user or the cell telephone user can employ the use of the adjunct application server 16 during telephony operations. At step 30, the adjunct application server 16 sends a query to the presence query task 18. The query includes an identifier such as a telephone number or a uniform resource identifier (URI) of the internal telephone device 100 of the internal user. At step 32, the presence query task 18 uses the identifier of the internal telephone device 100 to query the internal user's presence status from the presence engine 20. As indicated above, the presence engine 20 provides presence information by monitoring devices and applications to determine the internal user's presence.

If a presence status is received at the presence query task 18 from the presence engine 20, then the presence query task 18 searches the mapping database 22 to map the presence status received at step 34 to an appropriate audible presence status notification such as a tone, tone pattern or a pre-recorded audible announcement at step 36. The audible presence status notification is then forwarded to the adjunct application server 16 at step 38 and is played by the adjunct application server 16 to the one of the external telephone device user and the cell telephone device user employing the use of the adjunct application server 16 that resulted in the sending of the query at step 30. The presence service ends at step 42. As shown in FIG. 2, if there is no presence status available for the internal user or the method times out while waiting for the presence status and therefore no presence status is received at step 34, the presence service ends at step 42.

Although embodiments of the invention have been described and illustrated in detail, it will be appreciated that various modifications and changes can be made. In the examples described above, the presence query task 18 is connected to a mapping database for mapping a pre-recorded audible presence status notification in the form of an announcement to the presence status received from the presence engine 20. A mapping database can be used instead to map an audible tone or other audible indicator. Thus, rather than playing a pre-recorded announcement, a tone can be provided that the user recognizes as a presence status indication. For example, different tones or different patterns can be used to represent different presence status.

Further, the examples described above relate to one user being provided with presence status information for another user. Such presence status information can also be provided when a further user is added to a conference call for example, a telephone device user that is involved in call in progress with on or more other users can add a further user to the call in progress. The telephone device user already involved in the call is provided with presence status information for the further user prior to adding the further user to the call in progress.

It will also be appreciated that the adjunct application server 16 can include a text-to-speech component for dynamically generating an audible indication of presence status based on a presence status response from the presence query task. This is useful in the case in which a user, such as the first user or the second user in the first-described embodiment, sets their own presence status indications. Also, a test response from the presence query task can be converted into a speech response that is played for the first user. In this case, mapping using the mapping database 22 is unnecessary.

Unified communication capabilities use text-to-speech technology for providing email over the phone. Presence information for the sender of an email can also be provided audibly, for example, at the end of an email. Further, the present invention can also be employed, for example, along with an interactive voice response (IVR) system. Thus, presence information is provided to a user when an option is presented to connect to another person or persons. The user can therefore determine whether or not to choose an option based on presence information. As indicated above, options for call handling can be provided based on the presence status provided in the audible indication. For example, in the event that a user is busy, options can be provided to connect to an alternative number, for example, to a secretary at another telephone device (not shown) or to go directly to voice mail to leave a message for the second user.

Further still, the application can vary the presentation of the presence information that is provided such that the presence information that is provided differs for different users. For example, rules can be established to customize the presence information that is provided based on whether or not an incoming call is from an internal telephone device or an external telephone device, determined by the caller line identification. Similarly, specific presence information can be provided to only certain incoming calls, based on caller line identification. Therefore, an application can vary the presentation of the presence information that is provided such that certain information is provided only to pre-defined callers based on the caller line identification. Thus, the contact information based on the caller line identification is provided and, at step 36, the presence status is mapped to the appropriate pre-recorded audio or tone based on the caller line identification. Alternatively, audio is dynamically generated based on both the presence status and the caller line identification at step 36.

Still further alternatives and modifications may occur to those skilled in the art. All such alternatives and modifications are believed to be within the scope of the invention as defined by the claims appended hereto.

What is claimed is:

1. A method for facilitating communication between a first user and a second user, the method comprising:
receiving contact information for said second user at a presence query task, via an adjunct application server;
checking to determine presence status of said second user;
providing said presence status from said presence query task to said adjunct application server; and
providing said presence status from said adjunct application server through a telephony switch to said first user, said presence status provided to said first user in the form of an audible indication.

2. The method according to claim 1, wherein said presence query task and said adjunct application server are embodied in a single device.

3. The method according to claim 1, wherein said checking to determine presence status of said second user comprises querying said presence status of said second user, from a presence engine.

4. The method according to claim 3, wherein said audible indication comprises a tone or tone pattern.

5. The method according to claim 3, wherein said checking to determine presence status of said second user comprises said presence query task searching a mapping database to map said presence status from said presence engine to said audible indication.

6. The method according to claim 5, wherein said audible indication comprises a pre-recorded message.

7. The method according to claim 5, wherein said searching a mapping database to map said presence status from said presence engine to said audible indication is based on an identification of said first user.

8. The method according to claim 1, wherein said providing said presence status from said presence query task to said adjunct application server comprises providing a text indication of said presence status to said adjunct application server.

9. The method according to claim 1, wherein the adjunct application server dynamically converts said text indication of said presence status to an audio indication of said presence status for providing to said first user.

10. The method according to claim 9, wherein said text indication is provided based on a caller line identification of said first user.

11. The method according to claim 1, wherein said providing said presence status from said adjunct application server comprises dynamically generating said audible indication of said presence status and forwarding said audible indication to said first user.

12. The method according to claim 1, wherein said adjunct application server comprises a voice mail server and said receiving contact information comprises receiving contact information associated with a message left by said second user on said voice mail server.

13. The method according to claim 1, wherein said adjunct application server comprises an auto-attendant server and said receiving contact information comprises receiving contact information of said second user, through said telephone switch and said auto-attendant server.

14. The method according to claim 1, wherein said first user is involved in a telephone call with at least one further user prior to said receiving contact information for said second user, and said providing presence status comprises providing presence status form said adjunct application server to at least said first user.

15. The method according to claim 1, comprising providing options for call handling based on said presence status.

16. A system for facilitating communication between a first user and a second user, the system comprising:
a telephone switch for connecting a first user telephony device with a second user telephony device;
an adjunct application server connected to said telephone switch; and
a presence query task operating with the adjunct application server for checking to determine presence status of said second user and providing said presence status to said adjunct application server in response to a query received from said adjunct application server,
wherein said adjunct application server receives said presence status from said presence query task and provides said presence status to said telephony switch in the form of an audible indication.

17. The system according to claim 16, wherein said presence query task is part of said adjunct application server.

18. The system according to claim 16, comprising a presence engine in operation with said presence query task for querying said presence status of said second user.

19. The system according to claim 16, comprising a mapping database associated with said presence query task for mapping presence status to said audible indication.

20. The system according to claim 19, wherein said mapping database and said presence query task are embodied in a single device.

21. The system according to claim 16, wherein said adjunct application server comprises a text-to-speech converter for dynamically generating said presence status in the form of said audible indication.

22. The system according to claim 16, wherein said adjunct application server comprises one of a voice mail adjunct application server, an auto-attendant server, and an interactive voice response server.
